(19) United States
(12) Patent Application Publication
(10) Pub. No.: US 2013/0179672 A1
(43) Pub. Date: Jul. 11, 2013

(54) COMPUTER AND QUICK BOOTING METHOD THEREOF

(71) Applicants: Hsin-Yi Lee, Taipei City (TW); Chun-Liang Wu, Taipei City (TW); Shao-Hsing Hung, Taipei City (TW)

(72) Inventors: Hsin-Yi Lee, Taipei City (TW); Chun-Liang Wu, Taipei City (TW); Shao-Hsing Hung, Taipei City (TW)

(73) Assignee: ASUSTeK COMPUTER INC., Taipei City (TW)

(21) Appl. No.: 13/726,655

(22) Filed: Dec. 26, 2012

(30) Foreign Application Priority Data
Jan. 6, 2012 (CN) 201210003471.9

(51) Int. Cl. G06F 9/44; G06F 1/26

(52) U.S. Cl. CPC G06F 9/4401; G06F 1/26
USPC 713/2

(57) ABSTRACT

A computer and a quick booting method thereof are disclosed. The computer includes a central processing unit (CPU), a volatile memory, a basic input/output system (BIOS) and a power module. The volatile memory is coupled to the CPU and stores operation status data when the computer is power on before the computer executes a shutdown process. the BIOS is coupled to the CPU, reads the operation status data from the volatile memory when the computer executes a booting process, and initialize the computer according to the operation status data. The power module is coupled to the volatile memory and provides power to the volatile memory when the computer finishes the shutdown process. Since the operation status data stored in the volatile memory do not disappear after the computer finishes the shutdown process, they can be used to boot up the computer quickly.

### CROSS-REFERENCE TO RELATED APPLICATION

This application claims the priority benefit of China application serial No. 201210003471.9, filed on Jan. 6, 2012. The entirety of the above-mentioned patent application is hereby incorporated by reference herein and made a part of specification.

### BACKGROUND OF THE INVENTION

1. Field of the Invention

The invention relates to a quick booting method and, more particularly, to a quick booting method of a computer.

2. Description of the Related Art

As information technology develops, computers are widely used. In a conventional booting process of a computer, the computer loads the basic input/output system (BIOS) and the BIOS executes many steps after the computer is powered on, such as the steps of running the power-on self-test (POST), detecting hardware status, installing drive programs and loading the operation system.

However, since functions of the operation system are more powerful and auto-start applications in booting procedure become more, it takes longer time to load the operation system, and the user wastes more time in waiting for the computer booting, which is rather inconvenient.

Furthermore, as performance of the computer improves, an advanced configuration and power interface (ACPI) is used. A power management system of the computer divides operation states into six states, S0 to S5, according to an ACPI specification. At state S0, the computer operates normally and all of hardware devices are in operation. That is, the computer is in a normal booting state, and the central processing unit (CPU) and the applications are in operation. At state S1, the CPU stops operating and other hardware devices still operate normally. State S1 is also called power on suspend (POS). At state S2, the CPU is shutdown and other hardware devices still operate normally. At state S3, the computer stores operation states of the operation system and the applications to a random access memory (RAM), the RAM is still power on by a power supply and the hard disk drive (HDD) is shutdown. State S3 is usually called suspend to RAM (STR). At state S4, the computer stores the operation states of the operation system and the applications to a non-volatile memory (such as a hard disk), which means the operation status data stored in the RAM are write to the HDD. Then, all of components stop operating and the power supply stops providing power to the RAM, but the HDD still can be woken up. State S4 is also called suspend to disk (STD). At state S5, the computer is in a normal shutdown state and all of the hardware devices (including the power supply) are shutdown.

### BRIEF SUMMARY OF THE INVENTION

A quick booting method of a computer is disclosed. The quick booting method includes following steps: storing operation status data of the computer to a volatile memory when the computer executes a shutdown process, continuing providing power to the volatile memory after the shutdown process is finished, reading the operation status data from the volatile memory and initializing the computer according to the operation status data when the computer executes a booting process.

A computer is disclosed. The computer includes a CPU, a volatile memory, a BIOS and a power module. The volatile memory is coupled to the CPU and is used for storing operation status data before the computer executes a shutdown process. The BIOS is coupled to the CPU and is used for reading the operation status data from the volatile memory and initializing the computer according to the operation status data when the computer executes a booting process. The power module is coupled to the volatile memory and provides power to the volatile memory when the computer finishes the shutdown process.

These and other features, aspects and advantages of the present invention will become better understood with regard to the following description, appended claims, and accompanying drawings.

### BRIEF DESCRIPTION OF THE DRAWINGS

FIG. 1 is a block diagram showing a computer in an embodiment;

FIG. 2 is a block diagram showing a power module in an embodiment;

FIG. 3 is a block diagram showing a volatile memory in an embodiment; and

FIG. 4 is a flow chart showing steps of a quick booting method of a computer in an embodiment.

### DETAILED DESCRIPTION OF THE EMBODIMENTS

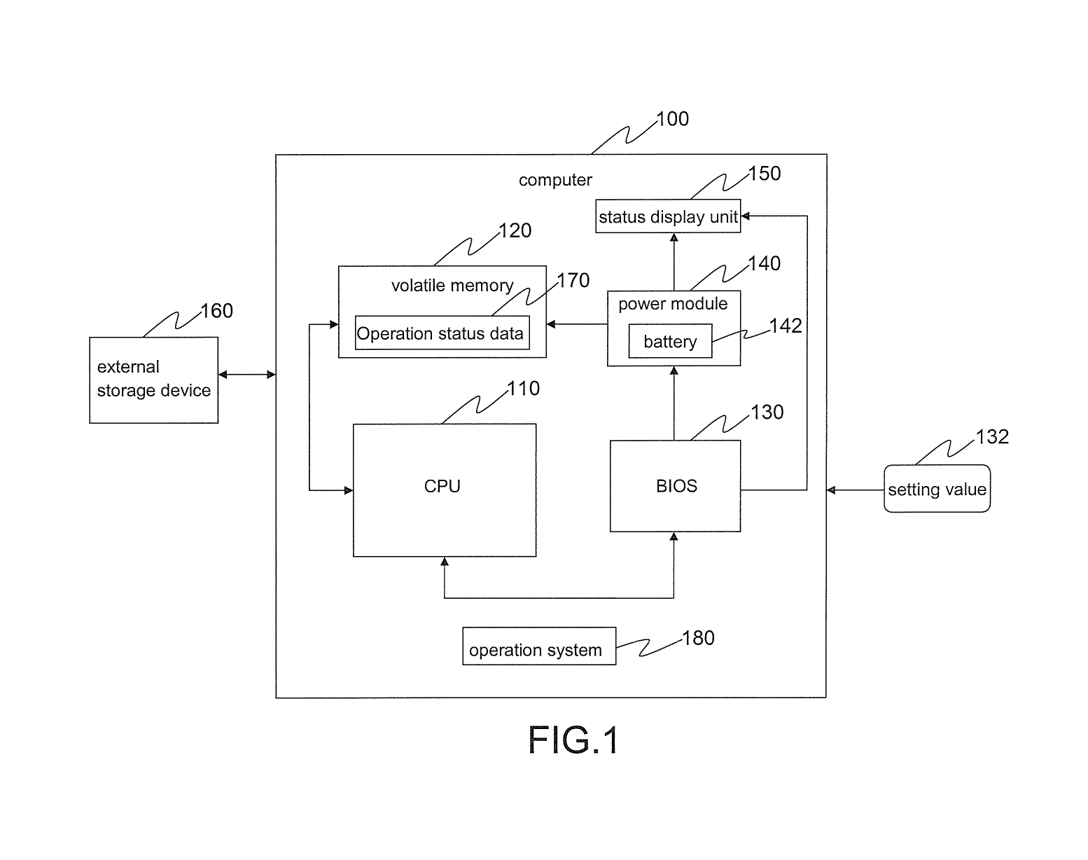

FIG. 1 is a block diagram showing a computer 100 in an embodiment. The computer 100 includes a CPU 110, a volatile memory 120, a BIOS 130 and a power module 140.

The CPU 110 executes commands and controls the operation of other components of the computer 100. The volatile memory 120 is coupled to the CPU 110 and at least stores operation status data 170 when the computer is working before the computer 100 executes a shutdown process. The shutdown process may be states entering state S4 or state S5, and the operation status data 170 before the shutdown process may be relating parameters at state S0, state S1, state S2 or state S3, which is not limited herein. In other words, the volatile memory 120 not only stores the operation status data 170, but it also may store other information or program codes. In an embodiment, the volatile memory 120 is a dynamic random access memory (DRAM), and in another embodiment, the volatile memory 120 is a double operation status data rate synchronous dynamic random access memory (DDR SDRAM), which is not limited herein. The volatile memory 120 may be a volatile storage of any kinds, and operation status data stored therein disappear when it is power off. In an embodiment, the volatile memory 120 includes at least a dual inline memory module (DIMM) coupled to the CPU 110 of the computer 100.

The BIOS 130 is coupled to the CPU 110, reads the operation status data 170 from the volatile memory 120 and initializes the computer 100 according to the operation status data 170 when the computer 100 executes a booting process. Since the operation status data 170 are operation status data before the computer 100 enters state S4 or state S5, when the computer 100 boots up (such as switching from state S5 to state S0), the BIOS 130 can make the computer 100 to restore to a state before shutdown rapidly according to the operation status data 170 stored in the volatile memory 120, and shorten the booting time of the computer 100.

The BIOS 130 may be a conventional legacy BIOS. In an embodiment, the BIOS 130 is an extensible firmware interface BIOS, (EFI BIOS), and the EFI BIOS may be a unified extensible firmware interface BIOS (UEFI BIOS), which is not limited herein.

When the CPU 110 executes the booting process for the first time, since the volatile memory 120 does not store the operation status data 170, the BIOS 130 initializes the computer 100 in a conventional booting process.

The power module 140 is coupled to the volatile memory 120 and provides power to the volatile memory 120 after the computer 100 enters state S4 or state S5. Thus, when the computer 100 enters state S4 or state S5, the volatile memory 120 is continuously powered by the power module 140, and the operation status data 170 stored in the volatile memory 120 do not disappear. In the embodiment, the power module 140 includes a battery 142 for providing power to the volatile memory 120 after the computer 100 finishes the shutdown process and enters state S4 or state S5.

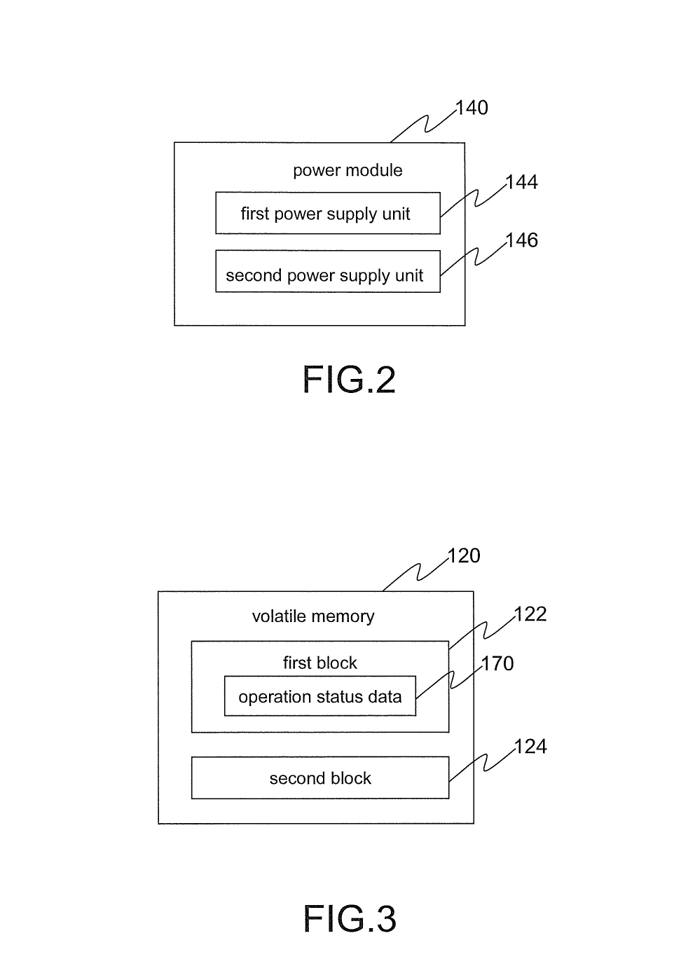

In the embodiment, the power module 140 includes a first power supply unit and a second power supply unit. Please refer to FIG. 2 and FIG. 1, FIG. 2 is a block diagram showing the power module 140 in the embodiment. Before the computer 100 executes the shutdown process, the first power supply unit 144 of the power module 140 provides power to the volatile memory 120. After the computer 100 finishes the shutdown process, the first power supply unit 144 stops providing power to the volatile memory 120, and the second power supply unit 146 of the power module 140 starts providing power to the volatile memory 120. In the embodiment, the second power supply unit 146 is the battery 142, and the first power supply unit 144 is an AC-DC converter in the computer 100. In another embodiment, when the computer 100 is at state S0, state S1, state S2 or state S3, the volatile memory 120 is powered by the first power supply unit 144. When the computer 100 is at state S4 or state S5, the volatile memory 120 is powered by the second power supply unit 146.

In the embodiment, the computer 100 includes a north bridge chip (not shown) coupled between the CPU 110 and the volatile memory 120, and the north bridge chip controls the access to the volatile memory 120. The computer 100 also includes a south bridge chip (not shown) coupled between the north bridge chip and a peripheral bus (such as a peripheral component interconnect (PCI) bus or a universal serial bus (USB)) for processing and transferring operation status data of components connected to the peripheral bus. The operation clock of the peripheral bus is usually lower than that of the volatile memory 120. In another embodiment, the north bridge chip and the south bridge chip can be integrated into the CPU 110.

Since the computer 100 includes the volatile memory 120 and the power module 140, the operation status data 170 can be stored to the volatile memory 120 after the computer 100 enters state S4 or state S5. Thus, the computer 100 can boot up rapidly according to the operation status data 170 stored in the volatile memory 120 without a solid HDD.

The volatile memory 120 includes a first block and a second block in an embodiment. Please refer to FIG. 3 and FIG. 1, FIG. 3 is a block diagram showing the volatile memory 120 in an embodiment. The operation status data 170 are stored in the first block 122 of the volatile memory 120. When the computer 100 executes the booting process, the access right of the second block 124 of the volatile memory 120 is given to the operation system 180 of the computer 100. The operation system 180 is run by the computer 100 to control the operation of the computer 100. After the computer 100 finishes the booting process, the operation system 180 uses the second block 124 as a cache. The BIOS 130 determines the first block 122 and the second block 124 according to a setting value 132. The setting value 132 can be set by the user and stored in the BIOS 130. After the computer 100 finishes the booting process, the operation system 180 cannot access the first block 122 until the computer 100 executes the shutdown process again.

Please refer to FIG. 1. In the embodiment, when the computer 100 executes the shutdown process, the operation status data 170 are stored to an external storage device 160. The external storage device 160 may be connected to the computer 100 via a USB, an IEEE 1394 interface or a serial advanced technology attachment (SATA). The external storage device 160 may also be a cloud storage device connected to the computer 100 via the Internet. When the power module 140 stops providing power to the volatile memory 120 and the operation status data 170 stored in the volatile memory 120 disappear, the BIOS 130 can read the operation status data 170 from the external storage device 160 to boot up the computer 100 rapidly.

In the embodiment in FIG. 1, the computer 100 further includes a status display unit 150 showing a state of the power module 140 providing power to the volatile memory 120. The display mode of the status display unit 150 changes according to whether the volatile memory 120 stores the operation status data 170. For example, when the volatile memory 120 stores the operation status data 170, the status display unit 150 flashes. When the volatile memory 120 does not store the operation status data 170, the status display unit 150 does not flash. The status display unit is a light emitting diode (LED) in the embodiment.

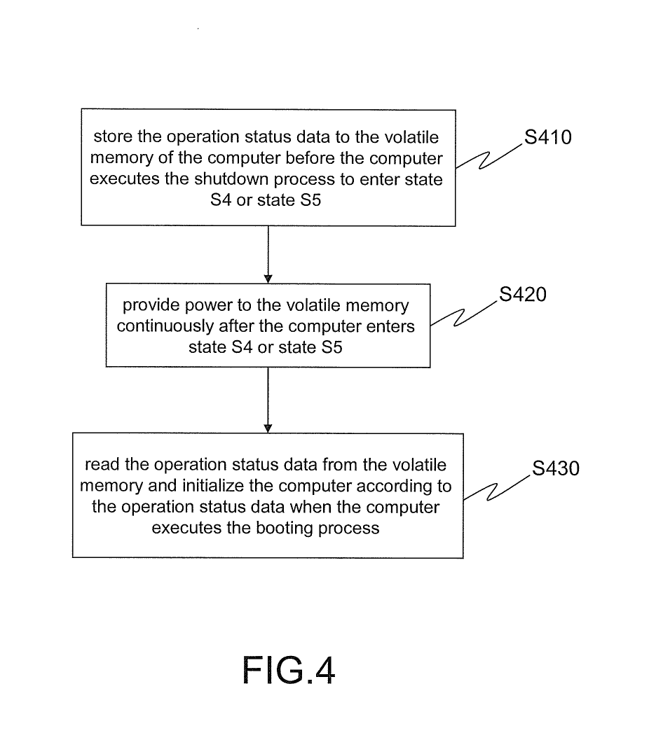

FIG. 4 is a flow chart showing steps of a quick booting method of the computer in an embodiment. In step S410, the computer 100 stores the operation status data 170 to the volatile memory 120 of the computer 100 before the computer 100 executes the shutdown process (such as the computer 100 entering state S4 or state S5). In step S420, the power module 140 provides power to the volatile memory 120 continuously after the computer 100 finishes the shutdown process (which means the computer 100 enters state S4 or state S5). In step S430, the BIOS 130 reads the operation status data 170 from the volatile memory 120 and initializes the computer 100 according to the operation status data 170 when the computer 100 executes the booting process.

In sum, since the operation status data stored in the volatile memory do not disappear when the computer executes the shutdown process, they can be used to boot up the computer rapidly.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A quick booting method of a computer, comprising following steps:
storing operation status data of the computer to a volatile memory when the computer executes a shutdown process;
continuing providing power to the volatile memory after the shutdown process is finished; and
reading the operation status data from the volatile memory and initializing the computer according to the operation status data when the computer executes a booting process.

2. The quick booting method according to claim 1, wherein the quick booting method further includes:
determining a first block and a second block in the volatile memory; and
giving an access right of the second block to an operation system of the computer when the computer executes the booting process;
wherein the operation status data are stored in the first block of the volatile memory.

3. The quick booting method according to claim 2, wherein the quick booting method further includes:
determining the first block and the second block according to a setting value.

4. The quick booting method according to claim 2, wherein the quick booting method further includes:
limiting the operation system not to access the first block until the computer executes the shutdown process again after the computer finishes the booting process.

5. The quick booting method according to claim 2, wherein the quick booting method further includes:
using the second block as a cache by the operation system after the computer finishes the booting process.

6. The quick booting method according to claim 1, wherein the computer includes a battery for providing power continuously to the volatile memory after the computer finishes the shutdown process.

7. The quick booting method according to claim 1, wherein the quick booting method further includes:
providing power to the volatile memory by a first power supply unit before the computer executes the shutdown process; and
providing power to the volatile memory by a second power supply unit after the computer finishes the shutdown process and stopping the first power supply unit from providing power to the volatile memory.

8. The quick booting method according to claim 1, wherein the volatile memory includes at least a dual inline memory module (DIMM) coupled to a central processing unit (CPU) of the computer.

9. The quick booting method according to claim 1, wherein the quick booting method further includes:
storing the operation status data to an external storage device when the computer executes the shutdown process.

10. A computer, comprising:
a CPU;
a volatile memory coupled to the CPU and storing operation status data before the computer executes a shutdown process;
a basic input/output system (BIOS) coupled to the CPU, reading the operation status data from the volatile memory and initializing the computer according to the operation status data when the computer executes a booting process; and
a power module coupled to the volatile memory and providing power to the volatile memory when the computer finishes the shutdown process.

11. The computer according to claim 10, wherein the power module includes a battery for providing power continuously to the volatile memory after the computer finishes the shutdown process.

12. The computer according to claim 10, wherein the power module includes:
a first power supply unit, wherein the first power supply unit provides power to the volatile memory before the computer executes the shutdown process; and
a second power supply unit, wherein the second power supply unit provides power to the volatile memory after the computer finishes the shutdown process, and the first power supply unit stops providing power to the volatile memory.

13. The computer according to claim 10, wherein the volatile memory includes at least a DIMM coupled to the CPU.

14. The computer according to claim 10, wherein the computer further includes a status display unit displaying a state of the power module providing power to the volatile memory.

15. The computer according to claim 14, wherein the status display unit is a light emitting diode (LED).
